(19) United States
(12) Patent Application Publication
(10) Pub. No.: US 2026/0140507 A1
(43) Pub. Date: May 21, 2026

(54) ROBOT PERCEPTION BASED TERRAIN RECOGNITION AND GAIT CONTROL METHODS, SYSTEMS, MEDIA, AND DEVICES

(71) Applicant: SHANDONG UNIVERSITY, Jinan (CN)

(72) Inventors: Guoteng ZHANG, Jinan (CN); Weikai DING, Jinan (CN); Zhengguo ZHU, Jinan (CN); Shijun XIAO, Jinan (CN); Rui SONG, Jinan (CN)

(73) Assignee: SHANDONG UNIVERSITY, Jinan (CN)

(21) Appl. No.: 19/392,111

(22) Filed: Nov. 17, 2025

(30) Foreign Application Priority Data
Nov. 19, 2024 (CN) 202411648442.7

(51) Int. Cl. G05D 1/495; B62D 57/032; G05D 109/12

(52) U.S. Cl. CPC G05D 1/495; B62D 57/032; G05D 2109/12

(57) ABSTRACT

Disclosed is a robot perception based terrain recognition and gait control method, system, medium, and device. The method includes: acquiring pitch angle data and foot force data of a bipedal robot based on optimal foot forces; inputting the pitch angle data and the foot force data into a trained k-nearest neighbor (KNN) model to recognize a terrain on which the bipedal robot is currently walking, and obtaining a terrain recognition result; a training process of the KNN model including: driving the bipedal robot to pass through a rough terrain and a flat terrain with a fixed step frequency gait, inputting collected pitch angle sample data and foot force sample data from different terrains into the KNN model, and using the KNN model to perform terrain classification; receiving the terrain recognition result, and adjusting step frequency and gait based on the terrain recognition result according to a preset gait control strategy.

### CROSS-REFERENCE TO RELATED APPLICATIONS

This application claims priority to the Chinese Patent Application No. 202411648442.7, filed on Nov. 19, 2024, the contents of which are hereby incorporated by reference.

### TECHNICAL FIELD

The present disclosure relates to a field of robot perception technology, and in particular, to a robot perception based terrain recognition and gait control method, system, medium, and device.

### BACKGROUND

A bipedal robot must accurately perceive terrain features in an unknown environment, possess the ability to accurately recognize these features, and make corresponding adjustments while processing terrain feature information in real time, ensuring that the robot can successfully traverse various complex terrains. Therefore, terrain recognition has become a critical function of the robot, which is of great significance for autonomous gait planning and real-time gait strategy adjustment, and is crucial for improving the adaptability and robustness of the bipedal robot in complex and dynamic environments.

Current robot-based terrain recognition methods require adding a plurality of sensors for data acquisition, resulting in high computational complexity and cost. Existing bipedal robot-based terrain recognition method, such as the Chinese application with application No. 202111661244.0 and titled “Robot Terrain Recognition and Speed Control Methods and Systems”, only use foot force data obtained from foot pressure sensors to characterize terrain features. However, the manner lacks constraints on the optimal foot force for the robot, and cannot ensure stable operation of the robot when only the foot force data is used, thereby failing to guarantee the accuracy of the terrain recognition.

### SUMMARY

One or more embodiments of the present disclosure provide a robot perception based terrain recognition and gait control method, comprising: acquiring pitch angle data and foot force data of a bipedal robot based on optimal foot forces; inputting the pitch angle data and the foot force data into a trained k-nearest neighbor (KNN) model to recognize a terrain on which the bipedal robot is currently walking, and obtaining a terrain recognition result; receiving, by a robot controller, the terrain recognition result, and adjusting a step frequency and a gait of the bipedal robot based on the terrain recognition result according to a preset gait control strategy; wherein a training process of the KNN model includes: driving the bipedal robot to perform autonomous navigation on a flat terrain and a rough terrain, and acquiring a sample dataset D1 and a sample dataset D2 including roll angles, pitch angles, and foot forces, respectively; extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and using a KNN algorithm for training, selecting a feature combination with a highest classification accuracy rate for experimental validation, recording a success rate of each group of tests, and determining an optimal k value to optimize model performance of the KNN model.

One or more embodiments of the present disclosure provide a robot perception based terrain recognition and gait control system, comprising: a data acquisition module, configured to acquire pitch angle data and foot force data of a bipedal robot based on optimal foot forces; a terrain recognition module, configured to input the pitch angle data and the foot force data into a trained KNN model to recognize a terrain on which the bipedal robot is currently walking, and obtain a terrain recognition result; and a gait control module, configured for a robot controller to receive the terrain recognition result, and adjust a step frequency and a gait of the bipedal robot based on the terrain recognition result according to a preset gait control strategy; wherein a training process of the KNN model includes: driving the bipedal robot to perform autonomous navigation on a flat terrain and a rough terrain, acquiring a sample dataset D1 and a sample dataset D2 including roll angles, pitch angles, and foot forces, respectively; extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and using a KNN algorithm for training, selecting a feature combination with a highest classification accuracy rate for experimental validation, recording a success rate of each group of tests, and determining an optimal k value to optimize model performance of the KNN model.

One or more embodiments of the present disclosure provide a non-transitory computer readable storage medium having a computer program stored thereon, wherein when the computer program is executed by a processor, operations in the robot perception based terrain recognition and gait control method are implemented.

One or more embodiments of the present disclosure provide a computer device, comprising a memory, a processor, and a computer program stored in the memory and executable on the processor, wherein when the computer program is executed, the processor implements operations in the robot perception based terrain recognition and gait control method.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which constitute a part of the embodiments of the present disclosure, are provided for further understanding of the embodiments of the present disclosure. The illustrative embodiments and descriptions thereof in the present disclosure are used to explain the embodiments of the present disclosure and do not constitute a limitation on the embodiments of the present disclosure.

FIG. 1 is a flowchart illustrating an exemplary process of a robot perception based terrain recognition and gait control method according to some embodiments of the present disclosure.

FIG. 2 is a schematic diagram illustrating a time series window according to some embodiments of the present disclosure.

FIG. 3 is a schematic diagram illustrating a simplified analysis of a single rigid body model according to some embodiments of the present disclosure.

FIG. 4 is a schematic diagram illustrating a friction cone constraint condition of a foot force according to some embodiments of the present disclosure.

FIG. 5 is a schematic diagram illustrating a pitch angle curve and a foot force curve on a flat terrain and a grassland terrain according to some embodiments of the present disclosure.

FIG. 6 is a schematic diagram illustrating a phase relationship of a flight gait according to some embodiments of the present disclosure.

FIG. 7 is a schematic diagram illustrating a phase relationship of a walking gait according to some embodiments of the present disclosure.

### DETAILED DESCRIPTION

In order to more clearly illustrate the technical solutions of the embodiments of the present disclosure, the drawings used in the description of the embodiments will be briefly introduced below. Obviously, the drawings in the following description are merely some examples or embodiments of the present disclosure. For a person of ordinary skill in the art, the present disclosure may be applied to other similar scenarios based on these drawings without creative efforts. Unless obviously obtained from the context or the context illustrates otherwise, the same numeral in the drawings refers to the same structure or operation.

It should be understood that the terms “system,” “device,” “unit,” and/or “module” used herein are manners for distinguishing different components, elements, parts, sections, or assemblies at different levels. However, if other words may achieve the same purpose, the words may be replaced by other expressions.

As shown in the present disclosure and the claims, unless the context clearly indicates an exception, the words “a,” “an,” “one,” and/or “the” are not specifically limited to the singular form and may also include the plural form. Generally, the terms “include” and “comprise” only suggest the inclusion of explicitly identified steps and elements, and these steps and elements do not constitute an exclusive list. A manner or device may also include other steps or elements.

The present disclosure uses flowcharts to illustrate the operations performed by the system according to the embodiments of the present disclosure. It should be understood that the preceding or following operations are not necessarily performed precisely in sequence. On the contrary, the steps may be processed in reverse order or simultaneously. Meanwhile, other operations may be added to these processes, or one or several operations may be removed from these processes.

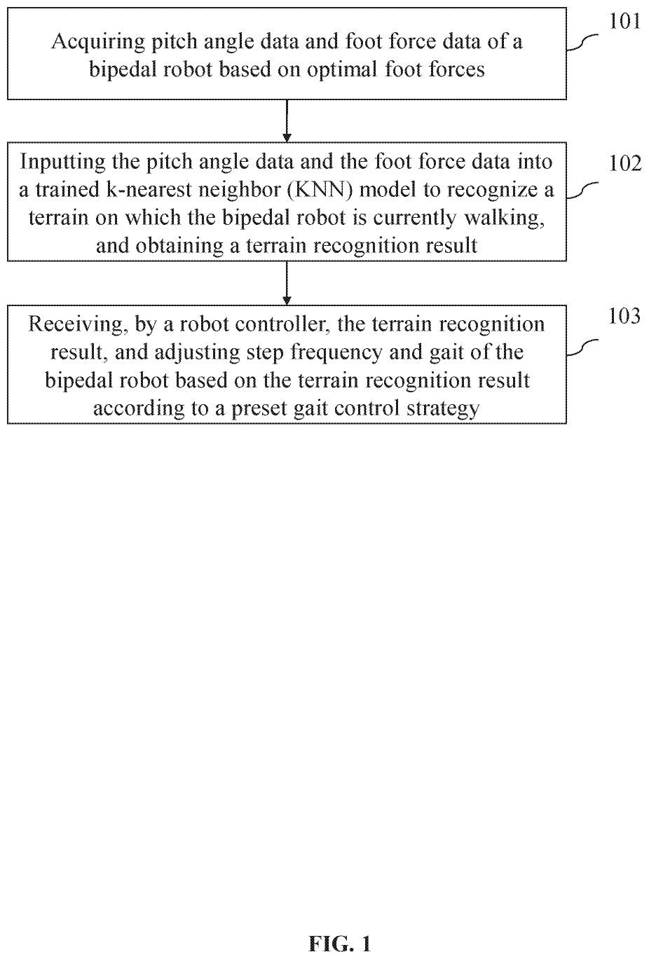

To solve the above problems, one or more embodiments of the present disclosure provide a robot perception based terrain recognition and gait control method, a system, a medium, and a device. The method first determines an optimal foot force to ensure stable operation of the robot. Under the constraint of the optimal foot force, the pitch angle data and the foot force data are used as classification features to obtain the ruggedness of the terrain, thereby achieving terrain classification. Based on this, the step frequency and the gait of the robot are adjusted, which improves the stability of the bipedal robot walking on different terrains while ensuring high accuracy of terrain recognition. For more content about the optimal foot force, please refer to the corresponding content in FIG. 1.

The one or more embodiments of the present disclosure are further described below with reference to the accompanying drawings and embodiments.

### Embodiment 1

As shown in FIG. 1, the present example provides a robot perception based terrain recognition and gait control method, which includes the following operations 101 to 103:

In operation 101, acquiring pitch angle data and foot force data of a bipedal robot based on optimal foot forces.

The optimal foot force is a foot-end contact force vector obtained by solving a quadratic programming problem under dynamics and contact constraints. The optimal foot force is primarily used to ensure the stability of motion control of the robot and serves as a high-quality data source for the terrain recognition module to improve recognition accuracy and robustness. For more content about the terrain recognition module, refer to the corresponding description in Example 2 of the present disclosure.

In some embodiments, the optimal foot force is obtained by simplifying a cost function into a standard quadratic programming problem and solving the standard quadratic programming problem.

In some embodiments, a process for determining the optimal foot force includes: performing a force analysis and a modeling operation on the bipedal robot to obtain ground reaction forces of two feet of the bipedal robot and position vectors starting from a center of mass and pointing to foot ends of the two feet, respectively; constructing a center-of-mass motion state equation based on the ground reaction forces of the two feet and the position vectors, and simplifying the center-of-mass motion state equation to obtain a center-of-mass dynamics equation including a desired center of mass linear acceleration and a desired body angular acceleration; constructing a constraint condition based on a stable motion; and constructing an optimization equation according to the center-of-mass dynamics equation and the constraint condition, simplifying a cost function into a standard quadratic programming problem, and solving the standard quadratic programming problem to obtain the optimal foot forces.

The ground reaction forces of two feet refer to the support forces applied by the ground to the two feet of the robot when the bipedal robot contacts the ground.

The center-of-mass motion state equation refers to a mathematical expression describing the translational and rotational motion laws of the center of mass of the bipedal robot.

The desired center of mass linear acceleration refers to a target linear acceleration that the center of mass of the bipedal robot should achieve under a specific motion target.

The desired center of mass linear acceleration is determined by a PD controller.

The desired body angular acceleration refers to a target angular acceleration that the body of the bipedal robot should achieve under a specific motion target.

The desired body angular acceleration may be determined by a PD controller based on a desired body posture and a measured body posture.

The center-of-mass dynamics equation refers to a mathematical expression describing the relationship between the forces and moments acting on the center of mass of the robot and the desired motion state.

The stable motion refers to a motion state in which the bipedal robot maintains balance during movement without tipping over or becoming unstable.

The constraint conditions are physical constraints constructed based on the stable motion of the robot. The constraint conditions may be preset according to the physical characteristics of the robot, the motion target, and environmental limitations. For more content about the constraint conditions, please refer to the corresponding description later.

The cost function is used to measure of the system control performance or state error. An optimization equation is established by minimizing the cost function to obtain an optimal control quantity or the optimal foot force.

The optimization equation may be solved by quadratic programming or convex optimization methods to achieve an optimal solution for gait control.

The standard quadratic programming problem is obtained by transforming and simplifying the cost function, which facilitates the use of a standard solver for solution.

In one or more embodiments of the present disclosure, by performing the force analysis and the modeling operation on the bipedal robot to determine the optimal foot force, the center-of-mass dynamics equation and the constraint conditions are further constructed, providing an accurate mathematical basis for the gait control of the robot, helping the robot maintain a stable motion state during walking, and improving the smoothness and safety of walking.

The pitch angle data refers to time-series data of a forward and backward tilting angle obtained by an inertial measurement unit (IMU) installed on the robot through state estimation and filtering. To ensure that the pitch angle data and the foot force data truly can reflect the ground contact characteristics, in the embodiments of the present disclosure, before data acquisition, the optimal foot force is determined and implemented to achieve stability of motion control, thereby improving the quality and reliability of subsequently acquired data.

The pitch angle data is obtained by a sensor installed at the head center of the bipedal robot.

The foot force data refers to information about the mechanical interaction generated when the soles of the bipedal robot contact the ground.

The foot force data may be directly measured by a force/moment sensor installed on the foot end, estimated by combining an output moment of the actuator with a dynamics model, or indirectly determined by a state estimation algorithm that fuses IMU and encoder data.

In operation 102, inputting the pitch angle data and the foot force data into a trained k-nearest neighbor (KNN) model to recognize a terrain on which the bipedal robot is currently walking, and obtaining a terrain recognition result.

The KNN model refers to a machine learning model constructed based on the K-Nearest Neighbor principle. Inputs of the KNN model include pitch angle sample data and foot force sample data from different terrains. Outputs of the KNN model include the terrain recognition result (e.g., a terrain category label and the confidence level).

The KNN model is trained by a K-Nearest Neighbor algorithm. For more content about the training of the KNN model, refer to the relevant description later.

The terrain recognition result refers to classification information describing the ground type of the environment in which the bipedal robot is located.

The terrain recognition result is output by the KNN model after judging the walking data of the bipedal robot.

In step 103, receiving, by a robot controller, the terrain recognition result, and adjusting a step frequency and a gait of the bipedal robot based on the terrain recognition result according to a preset gait control strategy.

The robot controller refers to a control unit responsible for decision-making and adjusting motion behaviors of the bipedal robot.

The preset gait control strategy refers to a set of rules that guide the bipedal robot to adjust the walking pattern and motion rhythm according to specific conditions. For more content about the gait control strategy, refer to the corresponding descriptions below.

The preset gait control strategy is formulated in advance based on robot design objectives and environmental characteristics.

The step frequency refers to a count of steps taken by the bipedal robot per unit time.

The gait refers to a specific pattern and sequence of leg movements of the bipedal robot during walking or motion.

The step frequency and the gait are selected based on the terrain recognition result and the preset gait control strategy.

Next, with reference to FIG. 1, the robot perception based terrain recognition and gait control method disclosed in this embodiment is described in detail. In the embodiment, the pitch angles and foot forces of the bipedal robot are fed back, and these data are input into a trained KNN model to achieve the terrain recognition.

To perceive a motion state of the bipedal robot on different terrains in real time, the embodiment uses an IMU sensor to capture motion information generated by interaction between the robot and the ground during motion: a pitch angle. As an important component of a robot navigation system, the IMU sensor integrates an accelerometer and a gyroscope, and can output three-axis acceleration data and three-axis angular velocity data simultaneously, with excellent sensitivity and accuracy, and is therefore widely used in motion measurement and somatosensory interaction fields.

The pitch angle data includes three-axis angular velocity information, which is acquired by a sensor installed at a head center of the bipedal robot. The sensor (IMU) is installed at the head center of the bipedal robot, wherein a Y-axis of the sensor is consistent with a forward direction of the bipedal robot, an X-axis of the sensor is parallel to a lateral direction of a chassis of the bipedal robot, and a Z-axis of the sensor is perpendicular to a chassis plane of the chassis; and angular velocity information of the Y-axis, the X-axis, and the Z-axis is respectively used to represent motion information of the bipedal robot in forward and backward tilting, left and right tilting, and turning motion.

Acceleration information of the X-axis, the Y-axis, and the Z-axis may reflect motion states of the bipedal robot in the lateral direction, the forward direction, and a vertical direction, respectively. Corresponding angular velocity information may reveal dynamic changes of the bipedal robot in the left and right tilting, the forward and backward tilting, and the turning motion.

The three-axis angular velocity information refers to quantitative information describing rotation rates of an object around three orthogonal coordinate axes. The three-axis angular velocity information is rotation angular velocities of the bipedal robot around the X-axis, the Y-axis, and the Z-axis, and is collected by the IMU installed at the head center.

The chassis refers to a main load-bearing structure or frame of the bipedal robot, which is used for installing various components and supporting an overall structure of the bipedal robot.

The chassis plane refers to a horizontal reference plane where the chassis of the bipedal robot is located.

The chassis plane is determined by a physical position of the chassis of the bipedal robot or a geometric center plane thereof.

The motion information of the forward and backward tilting, the left and right tilting, and the turning motion corresponds to posture changes of the bipedal robot during pitching, rolling, and changing the forward direction, respectively.

The forward and backward tilting, the left and right tilting, and the turning motion are perceived by obtaining angular velocity or posture changes of the bipedal robot through a sensor (e.g., a gyroscope).

Under an effective control of a count of sensors, fusion of multi-source information not only improves accuracy and robustness of the terrain recognition, enabling the bipedal robot to more accurately identify characteristics of different terrains, but also provides more detailed terrain feedback for the robot controller. On this basis, the bipedal robot may intelligently adjust the step frequency and the gait according to the recognition result, thereby maintaining optimal walking performance and stability in various complex terrains. The strategy of comprehensive perception and intelligent adjustment provided by the present disclosure significantly improves adaptive capability and task execution capability of the bipedal robot in unknown or changing environments, while reducing usage costs.

When the bipedal robot moves on different terrains at a certain speed, due to interaction between the bipedal robot and the ground, each channel of the IMU generates a unique signal waveform. Differences between these signals provide a basis for classification and recognition of different terrains.

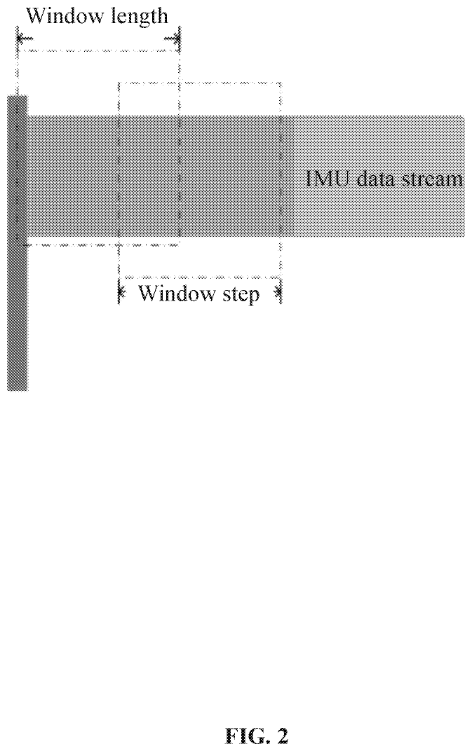

FIG. 2 is a schematic diagram illustrating a time series window according to some embodiments of the present disclosure.

Real-time data collected by the IMU sensor is typical continuous time series data. In this embodiment, a sliding window is used to perform frame segmentation on continuous data collected by the IMU sensor, dividing the continuous data into independent data frames. A “window length” defines a count of data points contained in each data frame, determining a time range covered by each data frame; and a “window step” defines a moving speed of the window on a data stream, i.e., an overlap degree or interval between two adjacent data frames, as shown in FIG. 2. The frame segmentation converts continuous and infinite-length time series data into a series of fixed-length data frames, thereby adapting to algorithm processing requirements, improving data processing efficiency, reducing memory usage, and facilitating subsequent terrain recognition tasks.

To ensure data accuracy and real-time performance, the embodiment sets a sampling frequency to 500 Hz. During a collection process, the IMU sensor records acceleration changes of the chassis in the lateral direction, the forward direction, and the vertical direction in real time, as well as angular velocity changes of the chassis in the left and right tilting, the forward and backward tilting, and the turning motion.

When discussing a dynamics model of the bipedal robot, the embodiment adopts a highly generalized manner, simplifying it into a framework of a single rigid-body system. A core of this abstraction process is to centrally simplify external forces acting on the entire system into mechanical actions at a contact interface between feet and the ground.

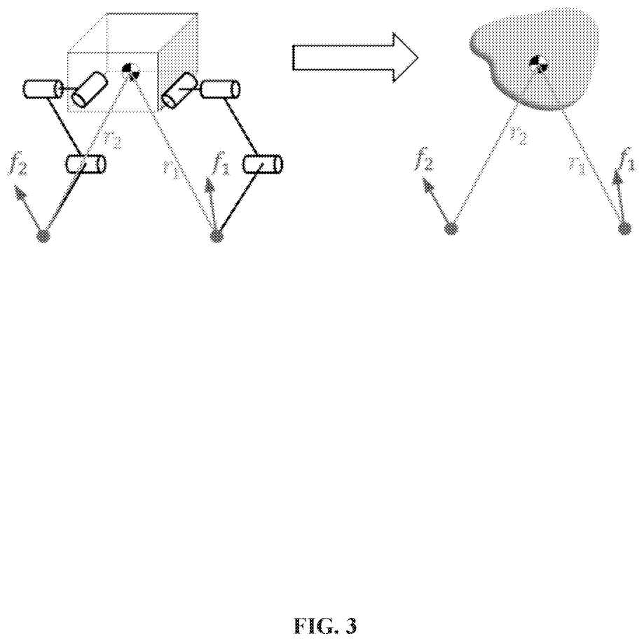

FIG. 3 is a schematic diagram illustrating a simplified analysis of a single rigid body model according to some embodiments of the present disclosure.

In FIGS. 3, f₁ and f₂ represent ground reaction forces of a left leg and a right leg in three-dimensional space, respectively. After model optimization processing, ground reaction forces of the left leg and the right leg of the bipedal robot in three-dimensional space in the left diagram are simplified into forces of the single rigid-body model in the right diagram, application points, magnitudes, and directions of these foot forces remain unchanged, ensuring accuracy of model simplification. r₁ and r₂, as position vectors, starting from a center of mass and pointing to foot ends of the left leg and the right leg, respectively, and they are precisely defined in a world coordinate system.

Based on the simplified single rigid-body model described above, the embodiment constructs a set of simplified dynamics equations according to basic principles in physics-Newton's second law and an angular momentum conservation equation, to accurately describe a center-of-mass motion state of the model:

$$m ( {\ddot{p}}_{COM} + g ) = {\sum }_{i = 1}^{2} {f}_{i} , \qquad ( 1 )$$

$$\frac{d ( I ω )}{dt} = {\sum }_{i = 1}^{2} {r}_{i} \times {f}_{i} . \qquad ( 2 )$$

In equations (1) and (2), m denotes a rigid-body mass of the bipedal robot simplified into a single rigid body; \hat{p}_{COM} denotes a linear acceleration at a center of mass of the bipedal robot; g denotes a gravitational acceleration; fᵢ denotes a ground reaction force of an i-th foot end (wherein i=1, 2, used to distinguish foot ends corresponding to the left leg and the right leg); r₁ denotes a position vector; I denotes a moment of inertia; ω denotes a rotation angular velocity; Iω denotes a moment of momentum (or angular momentum) of the rigid-body system.

Expanding and simplifying the left side of the equation yields:

$$\frac{d ( I ω )}{dt} = I \dot{ω} + ω \times ( I ω ) . \qquad ( 3 )$$

In equation (3), \dot{ω} denotes an angular acceleration at the center of mass of the bipedal robot; I\dot{ω} denotes a derivative of the moment of momentum with respect to time (an angular acceleration term).

Since the body may be approximately regarded as a relatively symmetrical cuboid, the product of inertia of the body may be ignored relative to the moment of inertia of the body, therefore:

$$ω \times ( I ω ) = [ \text{} \begin{matrix}0 & - {ω}_{z} & {ω}_{y} \\ {ω}_{z} & 0 & - {ω}_{x} \\ - {ω}_{y} & {ω}_{x} & 0\end{matrix} \text{} ] [ \text{} \begin{matrix}{I}_{xx} & 0 & 0 \\ 0 & {I}_{yy} & 0 \\ 0 & 0 & {I}_{zz}\end{matrix} \text{} ] [ \begin{matrix}{ω}_{x} \\ {ω}_{y} \\ {ω}_{z}\end{matrix} \text{} ] = [ \text{} \begin{matrix}( {I}_{zz} - {I}_{yy} ) {ω}_{y} {ω}_{z} \\ ( {I}_{xx} - {I}_{zz} ) {ω}_{x} {ω}_{z} \\ ( {I}_{yy} - {I}_{xx} ) {ω}_{x} {ω}_{y}\end{matrix} \text{} ] . \qquad ( 4 )$$

In the equation, ωₓ, ω_{y}, and ω_{z} denote angular velocities in the x, y, and z directions at the center of mass of the bipedal robot, respectively; Iₓₓ, I_{yy}, and I_{zz} denote moments of inertia of the bipedal robot about the x, y, and z axes, respectively.

During stable motion of the bipedal robot, the bipedal robot has a relatively small angular velocity. Therefore, quadratic terms of the angular velocity are considered to be zero. Further simplification yields:

$$\frac{d ( I ω )}{dt} \approx I \dot{ω} . \qquad ( 5 )$$

Furthermore, a unified center-of-mass dynamics equation may be obtained:

$${\underbrace{[ \begin{matrix}{II}_{3} & {II}_{3} \\ {[ {p}_{f 1} - {p}_{COM} ]}_{\times } & {[ {p}_{f 2} - {p}_{COM} ]}_{\times }\end{matrix} ]}}_{A} {\underbrace{[ \begin{matrix}{f}_{1} \\ {f}_{2}\end{matrix} ]}}_{f} = {\underbrace{[ \begin{matrix}m ( {\ddot{p}}_{d} + g ) \\ I {\dot{ω}}_{d}\end{matrix} ]}}_{b} . \qquad ( 6 )$$

In the equation, Π₃ is a 3×3 identity matrix; p_{f1} and p_{f2} respectively denote position vectors of foot ends of left and right legs in a world coordinate system; p_{COM} denotes a position vector of the center of mass in the world coordinate system, and the position vectors are obtained through a state estimation of the bipedal robot; superscripts are omitted for compact expression; \ddot{p}_{d} denotes a desired center of mass linear acceleration; \dot{ω}_{d} denotes a desired body angular acceleration; and the desired center of mass linear acceleration \ddot{p}_{d} and the desired body angular acceleration \ddot{ω}_{d} are determined by designing corresponding proportional-derivative (PD) controllers.

The world coordinate system refers to a relatively fixed and global reference coordinate system used to describe positions and postures of the bipedal robot and objects in corresponding environment.

p_{f1} may be obtained through state estimation or direct measurement of the bipedal robot.

p_{f2} may be obtained through state estimation of the bipedal robot.

The rigid-body mass refers to a total mass of an object regarded as non-deformable.

The rigid-body mass is determined or set after simplifying the bipedal robot system into a single rigid-body.

The moment of inertia refers to a physical quantity that measures an ability of an object to resist changes in its rotational state (i.e., rotational inertia).

The moment of inertia is determined based on mass distribution and geometric shape of the object, or obtained through experimental measurement.

The PD controller refers to a controller that corrects a system error by utilizing proportional and derivative feedback signals to generate a control instruction.

In one or more embodiments of the present disclosure, the center-of-mass dynamics equation unifies the center-of-mass position, the left and right foot end positions, the foot force, the mass, and the moment of inertia into dynamic representation, and provides the desired linear/angular acceleration through the PD controller. This ensures that a control output is consistent with actual dynamics, facilitating coupling with an optimization-based foot force distribution manner, thereby significantly improving balance stability, anti-disturbance capability, and gait adaptive performance of the bipedal robot on various terrains.

The desired center of mass acceleration may be determined as:

$${\ddot{p}}_{d} = {K}_{p , p} ( {p}_{d} - {p}_{C O M} ) + {K}_{d , p} ( {\dot{p}}_{d} - {\dot{p}}_{C O M} ) . \qquad ( 7 )$$

In the equation, p_{d} denotes a desired center-of-mass position; \dot{p}_{d} denotes a desired center-of-mass velocity; p_{d} and \dot{p}_{d} are generated by a control instruction input by a user and trajectory planning; and K_{p,p} and K_{d,p} denote gain coefficients of the PD controller, both being positive definite diagonal matrices.

The desired center-of-mass position refers to a target spatial coordinate that the center of mass of the bipedal robot should reach in a predetermined trajectory or task.

The desired center-of-mass velocity refers to a target linear velocity that the center of mass of the bipedal robot should reach in a predetermined trajectory or task.

The gain coefficients of the PD controller refers to parameters in the PD controller used to adjust an influence degree of a proportional term and a derivative term on a control output. In some embodiments of the present disclosure, gain coefficients of the PD controller include K_{p,p}, K_{d,p}, K_{p,ω}, and K_{d,ω}, preferably positive definite diagonal matrices.

In one or more embodiments of the present disclosure, by employing proportional-derivative (PD) control to determine the desired center of mass linear acceleration, the bipedal robot can adjust an acceleration output in real time based on a center-of-mass position and velocity deviation, thereby improving center-of-mass trajectory tracking accuracy and enhancing gait stability and rapid response capability to external disturbances.

Similarly, the desired body angular acceleration may be determined as:

$${\dot{ω}}_{d} = {K}_{p , ω} log ( {R}_{d} {R}_{b} ) + {K}_{d , ω} ( {ω}_{d} - {ω}_{b} ) . \qquad ( 8 )$$

In the equation, ω_{d} denotes a desired body angular velocity; ω_{b} denotes a measured body angular velocity; R_{d} denotes a desired body posture rotation matrix, belonging to SO(3); R_{b} denotes a measured body posture rotation matrix, belonging to SO(3), which may be used to measure a posture error; and K_{p,ω} and K_{d,ω} are the gain coefficients of the PD controller, both being positive definite diagonal matrices.

The desired body angular acceleration refers to a target angular acceleration that a body of the bipedal robot should reach under a specific motion objective.

The desired body angular acceleration is determined by the PD controller based on the desired posture and the measured posture.

The desired body posture refers to a target spatial orientation and tilt that the body of the bipedal robot should reach in a predetermined task or motion.

The measured body posture refers to an actual spatial orientation and tilt of the body of the bipedal robot.

The measured body posture is obtained in real time through a sensor such as an IMU.

The rotation matrix refers to a mathematical matrix used to describe rotational transformation of an object in three-dimensional space.

SO(3) denotes a special orthogonal group in 3D, which is a mathematical set used to describe rotation of a rigid body in three-dimensional space. In one or more embodiments of the present disclosure, by employing a rotation logarithm on SO(3) combined with PD control to generate the desired angular acceleration, high-precision, fast, and robust control of the body posture is achieved, facilitating coordination with foot force optimization and improving stability and energy efficiency of the bipedal robot on complex terrains.

When determining an optimal foot force configuration, a series of physical constraint conditions need to be considered to ensure rationality and practicality of the determination. When a swing leg is in a flight phase, its foot should be regarded as having no external force application point, i.e., a ground reaction force is strictly set to zero. Furthermore, regarding a foot force in a vertical direction (Z-axis), its magnitude is reasonably defined between a maximum threshold fₘₐₓ and a minimum threshold fₘᵢₙ based on physical reality, to prevent occurrence of unrealistic infinite values.

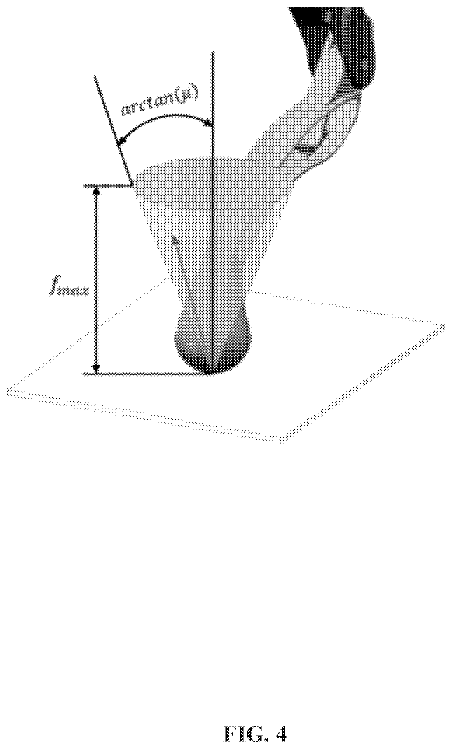

FIG. 4 is a schematic diagram illustrating a friction cone constraint condition of a foot force according to some embodiments of the present disclosure.

To ensure that the bipedal robot does not slip during contact with the ground, a horizontal component of the foot force must not exceed a limit value determined by a vertical component and a ground friction coefficient μ. This condition essentially confines the foot force vector within a cone-shaped space defined by friction characteristics, i.e., the so-called friction cone constraint condition. A value of μ may be set by looking up a table based on a terrain type (e.g., a value range is 0.05-1.0, where a value of μ for a slippery ground is 0.3, and a value of μ for a rough ground is 0.9). Alternatively, the value of μ may be estimated online through a foot force sensor and an IMU, and a range of the friction cone constraint condition may be adaptively adjusted, thereby improving gait stability and anti-slip capability. FIG. 4 intuitively illustrates a geometric form of this constraint condition.

The friction cone constraint condition may be expressed as:

$$\sqrt{{f}_{x}^{2} + {f}_{y}^{2}} \leq μ {f}_{z} . \qquad ( 9 )$$

In Equation (9), μf_{z} denotes the friction cone constraint condition; fₓ, f_{y}, and f_{z} respectively denote foot forces along an X-axis, a Y-axis, and a Z-axis.

The friction cone constraint condition refers to a restriction condition imposed on the foot force to prevent slipping during contact between the bipedal robot and the ground.

The friction cone constraint condition is formulated based on a ground friction coefficient and physical contact principles, and is typically expressed in an inequality form.

The foot forces along an X-axis, a Y-axis, and a Z-axis refer to force components in the X-axis, Y-axis, and Z-axis of a body coordinate system of the bipedal robot when a foot of the bipedal robot contacts the ground.

The foot forces along an X-axis, a Y-axis, and a Z-axis may be obtained as part of the foot force data through a foot sensor or a dynamics model.

Since the above equation is a nonlinear constraint, to incorporate the foot force constraint into a linear optimization of the foot force, it is modified into a linear friction force constraint:

$$\{ \begin{matrix}{f}_{min} \leq {f}_{z} \leq {f}_{max} \\ - μ {f}_{z} \leq \sqrt{2} {f}_{x} \leq μ {f}_{z} \\ - μ {f}_{z} \leq \sqrt{2} {f}_{y} \leq μ {f}_{z}\end{matrix} . \qquad ( 10 )$$

In Equation (10), fₘₐₓ and fₘᵢₙ denote a maximum foot force threshold and a minimum foot force threshold, respectively, with units of N. The meanings of the other formulas may be referred to the corresponding descriptions in Equation (9).

The maximum foot force threshold refers to a maximum allowable value that the foot of the bipedal robot can bear or exert in a certain direction. The minimum foot force threshold is a minimum allowable value that the foot of the bipedal robot can bear or exert in a certain direction.

The maximum foot force threshold is set based on the structural strength of the bipedal robot, the capability of the actuator, or safety requirements.

The minimum foot force threshold is set based on the stable support of the bipedal robot, contact maintenance, or control requirements.

In one or more embodiments of the present disclosure, the contact force and the friction cone constraint condition ensure physical feasibility and contact safety, and facilitate coupling with online optimization solution, thereby significantly improving the stability, robustness, and engineering implementability of the bipedal robot on complex terrain.

The linear friction force constraint may also be expressed in matrix form:

$${\underbrace{[ \begin{matrix}0 \\ 0 \\ 0 \\ 0 \\ {f}_{min}\end{matrix} ]}}_{\underline{c}} \leq {\underbrace{[ \begin{matrix}- \sqrt{2} & 0 & μ \\ 0 & - \sqrt{2} & μ \\ \sqrt{2} & 0 & μ \\ 0 & \sqrt{2} & μ \\ 0 & 0 & 1\end{matrix} ]}}_{c} {\underbrace{[ \begin{matrix}{f}_{x} \\ {f}_{y} \\ {f}_{z}\end{matrix} ]}}_{f} \leq {\underbrace{[ \begin{matrix}+ ∞ \\ + ∞ \\ + ∞ \\ + ∞ \\ {f}_{max}\end{matrix} ]}}_{\overline{c}} , \qquad ( 11 )$$

the desired foot force may be expressed as the optimization problem of Equation (12) and Equation (13):

$${f}^{d} {=}_{f ∈ {ℝ}^{3}}^{arg min ( {( A f - b )}^{T} S ( A f - b ) + {f}^{T} Wf )} . \qquad ( 12 )$$

In Equation (12), f denotes a foot force vector to be optimized, f includes fₓ, f_{y}, and f_{z}, S∈ [symbol] ^{6×6} denotes a positive definite diagonal matrix, which is used to describe an error weight of the foot forces following a desired motion state, f^{d} denotes a desired foot force vector (the optimal solution), A denotes a center of mass dynamics matrix, b denotes a desired motion force/moment vector, (⋅)^{T} denotes a transpose of a matrix or a vector, W∈ [symbol] ^{6×6} denotes a positive definite diagonal matrix, which is used as a penalty coefficient to avoid excessive foot force, and the constraint condition is used to satisfy the linear friction force constraints of the two feet.

The foot force vector to be optimized refers to a set of foot force vectors, as adjustable parameters, whose values need to be determined in the optimization problem.

The foot force vector to be optimized is defined as a variable that the algorithm needs to solve when the optimization problem is established.

The foot force vector refers to a vector containing the force components of the foot of the bipedal robot in different coordinate axis directions (e.g., X-axis, Y-axis, Z-axis).

The positive definite diagonal matrix refers to a diagonal matrix in which all elements on the diagonal are positive numbers.

The positive definite diagonal matrix is constructed based on its mathematical definition and specific requirements (e.g., weight allocation).

The error weight refers to the relative importance coefficient assigned to different error terms in an optimization or control system, used to adjust their influence on the total cost function or control output.

The error weight is allocated based on the influence degree of different error terms on the system performance and the design priority. That is, the greater the influence degree, the higher the error weight of motion with higher design priority; conversely, the smaller the error weight.

The desired foot force vector refers to an ideal foot force set to enable the bipedal robot to achieve a predetermined motion state and complete task objectives. The desired foot force vector is obtained by determining the optimization equation.

The center of mass dynamics matrix refers to the matrix in the center-of-mass dynamics equation used to correlate the foot force vector with the desired motion state of the bipedal robot.

The desired motion force vector refers to the set of forces required to represent the desired motion state of the bipedal robot in the center-of-mass dynamics equation of the bipedal robot.

$$s . t . {\underline{C}}_{i} \leq {C}_{i} {f}_{i} \leq {\overline{C}}_{i} i = 1 , 2. \qquad ( 13 )$$

In Equation (13), s.t. denotes a constraint condition. Cᵢ denotes a coefficient matrix of an i-th foot end friction cone constraint. fᵢ denotes a foot force vector of the i-th foot end, with a unit of N. Cᵢ denotes a lower bound vector of a constraint condition of the i-th foot end (e.g., fₘᵢₙ), and C̅ᵢ denotes an upper bound vector of the constraint condition of the i-th foot end (e.g., fₘₐₓ, +∞, etc.).

In Equation (13), Cᵢ, Cᵢ, C̅ᵢ are the contact constraint coefficients and upper and lower bounds constructed based on the linearization of the friction cone, the upper and lower limits of the normal force, etc.

The coefficient matrix of the foot end friction cone constraint refers to a matrix in the linear friction force constraint condition that correlates the foot force vector with the upper and lower bounds of the friction cone constraint.

The foot force vector of foot end refers to a vector describing the foot force components in various directions for a single foot end of the bipedal robot.

The foot force vector of the foot end is obtained by measuring with a foot sensor or calculating with a dynamics model, denoting the force on a single foot in vector form.

The lower bound vector of the constraint condition of foot end refers to the vector that specifies the minimum allowable value of the variable or force component in the constraint condition applied to a single foot end of the bipedal robot. Conversely, the upper bound vector of the constraint condition of the foot end is the vector of the aforementioned maximum allowable value.

The lower bound vector and the upper bound vector of the constraint condition of the foot end are set based on physical limitations, safety requirements, and motion stability conditions.

It may be seen that the cost function described by the above equation is a convex function, which may be solved using a quadratic programming problem. The standard quadratic programming problem may be expressed as:

$${min}_{U} \frac{1}{2} {U}^{T} H U + {U}^{T} g . \qquad ( 14 )$$

$$s . t . \underline{C} \leq C U \leq \overline{C} . \qquad ( 15 )$$

In Equation (14), U denotes an optimization variable of the standard quadratic programming problem, H denotes a quadratic coefficient matrix, C denotes a total constraint lower bound vector, C̅ denotes a total constraint upper bound vector, and C denotes a total constraint coefficient matrix.

Therefore, it is necessary to transform the cost function in the formula and simplify the cost function into the standard quadratic programming problem:

$$J ( f ) = {( A f - b )}^{T} S ( A f - b ) + {f}^{T} Wf = {( A f )}^{T} S A f - {( A f )}^{T} S b - {b}^{T} S A f + {b}^{T} S b + {f}^{T} Wf = {f}^{T} {A}^{T} S A f - 2 {f}^{T} {A}^{T} S b + {f}^{T} W f + {b}^{T} Sb = {f}^{T} ( {A}^{T} S A + W ) f + {f}^{T} ( - 2 {A}^{T} S b ) + {b}^{T} Sb . \qquad ( 16 )$$

In Equation (16), J(f) denotes the cost function, and the meanings of A, S, W, f, and b are the same as that in Equation (12). b^{T}Sb is not a function of f and does not affect the quadratic programming problem. It may be regarded as a constant term. Therefore, the matrices U, H, and g in the above formula may be expressed as:

$$\{ \begin{matrix}U = f \\ H = 2 ( {A}^{T} S A + W ) \\ g = - 2 {A}^{T} S b\end{matrix} . \qquad ( 17 )$$

In Equation (17), U=f indicates that the optimization variable of the standard quadratic programming problem is equivalent to the foot force vector to be optimized, H=2(A^{T}SA+W) indicates that the Hessian matrix is determined by the dynamics matrix and the weight matrix, g=−2A^{T}Sb indicates that the gradient vector is determined by the desired foot force and the weight. So far, the described optimal foot force determining problem has been transformed into a quadratic programming problem.

The optimization variable refers to the unknown quantity whose value may be adjusted to find the optimal solution in an optimization problem.

The quadratic coefficient matrix refers to the coefficient matrix related to the quadratic term in the objective function of the quadratic programming problem.

The quadratic coefficient matrix is derived based on the quadratic expression of the objective function.

The total constraint lower bound vector refers to the set vector of the minimum allowable values of variables or expressions corresponding to all linear constraint conditions in the standard quadratic programming problem. Conversely, the total constraint upper bound vector is the set vector of the aforementioned maximum allowable values.

The total constraint lower bound vector and the total constraint upper bound vector are constructed by integrating the minimum allowable values and the maximum allowable values of all individual constraint conditions, respectively.

The total constraint coefficient matrix refers to the coefficient matrix that correlates the optimization variable with all the linear constraint conditions in the standard quadratic programming problem.

The total constraint coefficient matrix is constructed by integrating coefficient matrices of all the individual constraint conditions.

The quadratic programming problem is transformed by expressing the optimization objective and the constraint conditions in quadratic and linear forms, and is determined using a specialized solver.

In one or more embodiments of the present disclosure, the desired foot force is formulated as a convex quadratic programming problem with physical constraints, which not only ensures physical consistency in force distribution and contact safety, but also supports efficient and stable real-time solution due to its convexity and standardized form, thereby significantly improving stability, robustness, and engineering implementability of gait control of bipedal robot.

In the embodiment, when designing the foot force configuration, not only the optimal force distribution is considered, but also physical constraint conditions (such as the maximum foot force threshold and the minimum foot force threshold) are introduced, which helps ensure the practicality and safety of the model. In the flight phase of the swing leg, the ground reaction force is strictly set to zero, which is a fine control of dynamic behavior of the bipedal robot and helps to more accurately simulate and control walking dynamics of the bipedal robot.

By first configuring the optimal foot force, the embodiment can provide a set of constraint conditions suitable for the motion characteristics of the bipedal robot. These constraint conditions not only ensure the stability of the bipedal robot during operation, but also provide an accurate and reliable basis for subsequently acquiring the pitch angle data and the foot force data. Only by ensuring stable operation of the bipedal robot, precise and error-free data can be acquired, providing strong support for further optimizing performance of the bipedal robot and improving walking efficiency.

In some embodiments, the training process of the KNN model specifically includes: driving the bipedal robot to perform autonomous navigation on a flat terrain and a rough terrain, and acquiring sample datasets including a sample dataset D1 and a sample dataset D2 including roll angles, pitch angles, and foot forces, respectively; extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and using a KNN algorithm for training, selecting a feature combination with a highest classification accuracy rate for experimental validation, recording a success rate of each group of tests, and determining an optimal k value to optimize model performance of the KNN model.

The roll angle refers to quantitative information describing changes in the motion state of the bipedal robot in direction of the left and right tilting.

The roll angle is acquired from the three-axis angular velocity information output by an IMU sensor.

The sample datasets refer to a data collection containing various related information such as the roll angle, the pitch angle, and the foot force, used for data analysis and model construction. Sample datasets include the sample dataset D1 and the sample dataset D2, which respectively represent sample datasets from two different types of terrain (D1 represents the “flat” dataset, and D2 represents the “rough/non-flat” dataset).

The sample datasets are acquired by driving the bipedal robot to perform autonomous navigation on different terrains.

The coefficient of variation of the sample data refers to a statistic used to measure the dispersion degree of the sample data, expressed as the ratio of the standard deviation of the sample data to the average value of the sample data.

The coefficient of variation is determined using the sliding window algorithm.

The training set and the validation set are obtained by randomly dividing the sample datasets according to a preset ratio. For example, the sample datasets are randomly divided into a training set, a validation set, and a test set according to a preset ratio (e.g., 70%/15%/15% or 80%/10%/10%).

The sliding window algorithm refers to a general manner that moves a window of fixed or variable size over a data sequence to process or analyze local data.

The window size refers to a count of data units contained in a single data segment or data frame during data processing.

The window size and the interval are determined according to the data printing frequency. The window size is positively correlated with the data printing frequency, and the interval is negatively correlated with the data printing frequency.

The data printing frequency refers to the rate at which a system or a sensor outputs or records data.

The data printing frequency is set by system design or sensor configuration.

The KNN algorithm performs classification or regression by determining the distance between a new sample and K nearest neighbor samples in the training set.

The classification accuracy rate is used to measure the accuracy of the KNN model in recognizing terrain categories.

The classification accuracy rate is evaluated by comparing the prediction results of the model on the validation set with the true labels, or by K-fold cross-validation. The classification accuracy rate refers to a proportion of samples whose categories are correctly identified or predicted by a machine learning model on a given dataset, and a calculation formula of the classification accuracy rate is:

$$Accuracy = \frac{{N}_{correct}}{{N}_{total}} \times 100 \% .$$

In Equation, N_{correct} is a count of samples where the prediction results are consistent with the true labels, and Nₜₒₜₐₗ is a total count of validation samples. In this embodiment, the sample datasets are divided into a training set and a validation set, the training set is used to train the KNN model, and the classification performance of the model is tested on the validation set. The predicted category of each sample in the validation set is compared with the true category manually annotated, the count of correctly predicted samples is counted, and the classification accuracy rate is determined according to the above formula. To improve evaluation reliability, K-fold cross-validation is further used to determine the average classification accuracy rate and the standard deviation. For example, when k=5 and the input features are the combination of the coefficient of variation and the variance, the average classification accuracy rate of the model reaches over 92%, demonstrating good stability.

The k value refers to the count of neighbor samples referenced for determining the prediction results in the nearest neighbor algorithm.

The optimal k value is determined by comparing the performance (e.g., prediction accuracy rate) of the model under different values. The optimal k value is determined through cross-validation. For example, a plurality of candidate k values are set, the classification accuracy rate is determined on the validation set respectively, a performance curve is plotted, and the k value with the highest accuracy rate is selected as the optimal value.

Model performance refers to the performance level of a machine learning model on a specific task (e.g., classification or regression).

The model performance is comprehensively evaluated using metrics such as the classification accuracy rate, confusion matrix, the standard deviation, and recognition delay, and the feature combination with the highest training accuracy rate and the optimal k value are taken as the final model parameters, thereby achieving high accuracy and stability in the terrain recognition while ensuring real-time performance.

To ensure the effectiveness of the KNN model, the embodiment uses K-fold cross-validation to evaluate the model. The original training dataset is equally divided into k sub-datasets, and a plurality of training and validation operations are performed.

First, the entire training set is divided into k subsets to ensure that each subset contains approximately the same count of samples. Then, k iterations are performed. In each iteration, one subset is selected as the validation set, and the remaining K−1 subsets are used as the training set. The K−1 subsets are used to train the model, and the model performance is evaluated on the selected validation set, thereby obtaining the evaluation result for that iteration. Then, the validation set is replaced and the above steps are repeated until each subset is considered as a validation set. A total of k iterations are performed, and k evaluation results are obtained. Finally, the average value of these k evaluation results is determined as the final accuracy rate of the model performance. The average value can more comprehensively reflect the model's performance on different data subsets, thereby avoiding bias that may be caused by a single division.

Specifically, the bipedal robot performs autonomous navigation on a flat terrain and a grassland terrain, while obtaining proprioceptive information from feedback, such as a roll angle R, a pitch angle P, and an estimated foot force F, to obtain the dataset D1 for the flat terrain and the dataset D2 for the grassland terrain.

$${D}_{1 , 2} = [ \begin{matrix}R & P & F\end{matrix} ] . \qquad ( 18 )$$

In Equation (18), D_{1,2} denotes datasets used for training and validating a KNN model. The subscript typically refers to sample sets of two different types of terrain, i.e., the dataset D1 for flat terrain and the dataset D2 for the grassland terrain, R refers to a roll angle, P refers to a pitch angle, and F refers to an estimated foot force. Each sample data includes a roll angle, a pitch angle, and foot force information of the bipedal robot at that moment.

Since a data printing frequency is 100 Hz and printed data are a large count of discrete points, statistical characteristics of the data are extracted as data features. Here, the coefficient of variation and the variance of the data are selected as the statistical characteristics and the data features, and a determination formula for the coefficient of variation is:

$$C V = \frac{σ}{μ} \times 100 \% . \qquad ( 19 )$$

In Equation (19), CV denotes the coefficient of variation, σ denotes a standard deviation of data, and μ denotes an average value of the data. After determining the coefficient of variation and the variance, a matrix N is obtained:

$$N = [ \begin{matrix}{R}_{cv} & {R}_{v} \\ {P}_{c v} & {P}_{v} \\ {F}_{cv} & {F}_{v}\end{matrix} ] . \qquad ( 20 )$$

Where R_{cv}, P_{cv}, and F_{cv} respectively denote the coefficients of variation of the roll angles, the pitch angle, and estimated foot force data, and Rᵥ, Pᵥ, and Fᵥ respectively denote the variance of the roll angles, the pitch angles, and the estimated foot force data.

The estimated foot force data refers to information obtained through calculation or inference manners, used to characterize mechanical action at a foot of the bipedal robot.

The estimated foot force data is obtained through calculation manners such as a mathematical model, an optimization algorithm, or sensor data fusion.

Relevant content regarding the coefficient of variation, the data printing frequency, the roll angle, the pitch angle, etc., may be referred to corresponding descriptions above.

In one or more embodiments of the present disclosure, a feature matrix N composed of the coefficient of variation and the variance is adopted, which incorporates both normalization and amplitude information, and features simple calculation and strong discriminative power, thereby achieving real-time, robust, and efficient terrain recognition and gait adaptation.

For the dataset D1 and the dataset D2, they are each evenly divided into 100 subsets N1, N2, . . . , N100. For each subset N1, a coefficient of variation and a variance are determined once every 100 data according to a sliding window algorithm, with a window interval of 50 data. After completion of the calculation, the dataset D1 for flat terrain is defined as a label 0, denoting flat terrain. The dataset D2 for the grassland terrain is defined as a label 1, denoting the grassland terrain. The 200 subsets (composed of 100 subsets from the dataset D1 and 100 subsets from the dataset D2) are merged and shuffled, and divided into a training set of 70% and a validation set of 30% according to steps of a KNN algorithm, where division of the training set and the validation set is random. In this preprocessing stage, the roll angle, the pitch angle, and the estimated foot force of the bipedal robot are used as inputs, and corresponding coefficients of variation and variances are used as outputs.

For the KNN algorithm, the coefficient of variation and the variance of the roll angles, the pitch angles, and the estimated foot force data of the bipedal robot are used as two features input to the KNN algorithm for training; two features from different sample data are combined pairwise to generate feature combinations, traverse all possibilities of feature combinations, and the classification accuracy rate corresponding to the feature combinations are calculated respectively, which is expressed as:

$$f ( {N}_{ij} , {N}_{kj} ) , i = 1 , 2 ; j = 1 , 2 , 3. \qquad ( 21 )$$

In the equation, i and k denote feature types (R: roll angle, P: pitch angle, F: foot force), j denotes statistical characteristics of the features (cv: coefficient of variation, v: variance), and k≠i denotes selecting different feature types for combination.

In one or more embodiments of the present disclosure, by performing pairwise combination and traversing on coefficients of variation and variances of the roll angles, the pitch angles, and the foot force and selecting an optimal combination based on a training accuracy rate, terrain recognition accuracy is improved while considering real-time performance and engineering feasibility.

As a specific implementation manner, for classifying flat terrain and the grassland terrain, selecting a variance of the pitch angles and a variance of the foot force as two classification features for the KNN classification algorithm yields a highest accuracy rate. Therefore, this solution is selected for experimental verification.

In the embodiment, the bipedal robot is driven to pass through two types of terrain with a same step frequency and a same gait, and datasets is formed through sampling. The entire datasets are divided into a training set and a test set. A K-fold cross-validation manner is used. Preferably, the datasets are divided 10 times and 5 times respectively, and the average value of a plurality of evaluation results is taken to reduce impact of model overfitting. A ratio of training data to test data is preferably set to 7:3. The training data includes pitch angles and forefoot foot forces on five types of hard flat terrain and soft grassland terrain.

The robot is drived to move on the flat terrain, a pitch angle and an estimated foot force of the robot are recorded in real time, and a variance is determined once every 100 data of the recorded data, and input into the KNN model to obtain a classification result (outputting a classification label 0 or 1). The classification result is printed once every 0.1 s. The same applies to the grassland terrain. Finally, classification results and accuracy rates for the flat terrain and the grassland terrain are obtained.

Accuracy of the terrain recognition is one of key indicators for measuring performance of a terrain detection algorithm of the bipedal robot. When the bipedal robot moves on a specific ground, output results of a ground feature perception algorithm are recorded in real time (a recording frequency of 10 Hz). On each terrain, at least 100 terrain recognition results are continuously recorded. If a k-th recognition is correct, it records Xₖ=1, otherwise, it records Xₖ=0. It is assumed that a total of n experiments are performed, then a success rate of the test is expressed as:

$$γ = \frac{1}{n} {\sum }_{i = 1}^{n} {x}_{i} \times 100 \% . \qquad ( 22 )$$

In Equation (22), γ refers to a success rate of the test, and xᵢ refers to a recognition result of a single sample. After completing two typical ground tests, one set of tests ends, and a success rate of each set of tests is recorded. Finally, an average success rate of all sets is recorded.

In the KNN algorithm, selection of the k value has an important impact on the model performance. Therefore, following an analysis idea of applying the KNN algorithm, prediction accuracy rates of the training set and the test set are calculated respectively when the k value ranges from 1 to 20 in the dataset. By comparing accuracy rates under different k values, an optimal k value may be determined to optimize the model performance.

When the K-fold cross-validation is divided into 10 times, a prediction accuracy rate of the test set is as shown in Table 1.

TABLE 1
accuracy rate of test set during 10-time k-fold cross-validation

| K value | K = 13 | K = 11 | K = 9 | K = 7 | K = 5 | K = 3 |
|---|---|---|---|---|---|---|
| Accuracy rate | 93.2% | 96.9% | 98.3% | 91% | 97.7% | 96.7% |

When the K-fold cross-validation is divided into 5 times, the prediction accuracy of the test set is shown in Table 2.

TABLE 2
accuracy of the test set during 5-time k-fold cross-validation

| K value | K = 13 | K = 11 | K = 9 | K = 7 | K = 5 | K = 3 |
|---|---|---|---|---|---|---|
| Accuracy rate | 96.6% | 96.2% | 97.7% | 97.1% | 97.2% | 96.6% |

As show in the table, the best choice for accuracy rate of the test set from low to high is k=9, and when k is greater than 9, the accuracy rate shows a downward trend. Therefore, the optimal k value in the embodiment is 9.

Then the KNN model is constructed. In the embodiments, K=9 is selected to process training data and test data, and a pitch angle curve and a foot force curve on the hard flat terrain and the grassland terrain are obtained.

For example, a process of training the KNN model includes: first collecting and synchronizing raw data with timestamps through an IMU and a foot force sensor (i.e., the sample dataset D1 and the sample dataset D2 including the roll angle, the pitch angle, and the foot force), performing low-pass filtering and preprocessing according to a preset printing frequency; using a sliding window algorithm for framing, and converting a window time length T_{w} and a step size Tₛ (e.g., T_{w}=1.0 s, Tₛ=0.5 s) to obtain sample counts N_{w}=round(T_{w}fₚ), Nₛ=round(Tₛfₚ); for each frame, determining statistical characteristics (the variance and the coefficient of variation of the roll angles/the pitch angles/the foot force data) to obtain a feature vector, which is combined with a terrain label to form the sample datasets; dividing the sample datasets into the training set and the validation set, first performing standardization (z-score) on the training pool, and then performing stratified K-fold cross-validation (e.g., 5-fold) on candidate feature combinations and k values to select an optimal feature combination and an optimal k value; finally, using the selected hyperparameters to construct a model on the training pool and evaluate the accuracy rate, the confusion matrix, and the success rate on an independent test set.

In some embodiments, the trained KNN model is deployed to the robot controller for receiving real-time pitch angle data and foot force data and outputting a terrain recognition result.

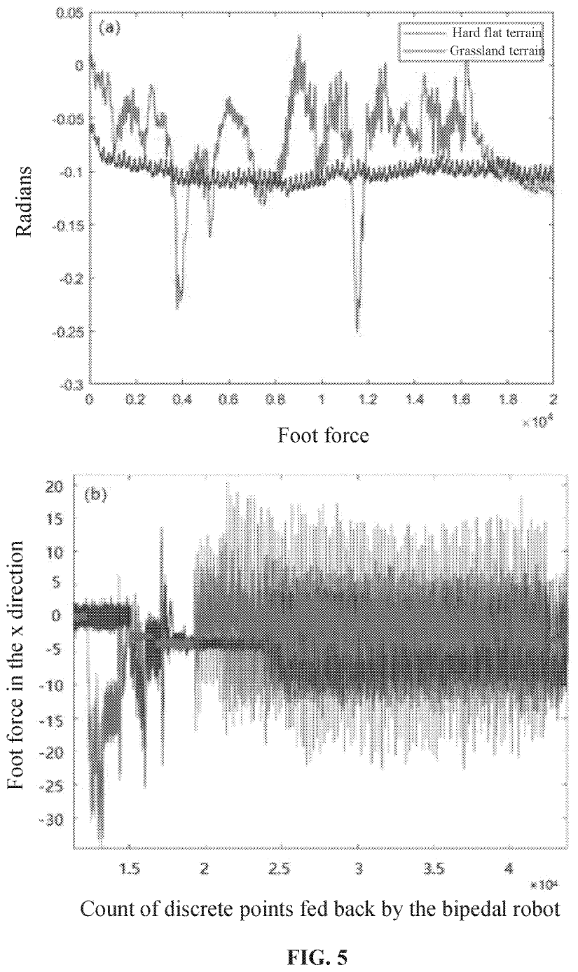

FIG. 5 is a schematic diagram illustrating a pitch angle curve and a foot force curve on a flat terrain and the grassland terrain according to some embodiments of the present disclosure. As shown in FIG. 5, in curve a, the horizontal coordinate is foot force (×10⁴), and the vertical coordinate is radians; in curve b, the horizontal coordinate is a count of discrete points (×10⁴) fed back by the bipedal robot, and the vertical coordinate is foot force in the x direction.

In curves a and b, the red curve denotes values corresponding to the hard flat terrain, and the blue curve denotes values corresponding to the grassland terrain. Obviously, there are clear differences in value fluctuation conditions and value point distributions between the hard flat terrain and the grassland terrain.

It can be seen that in the hard flat terrain and soft grassland terrain environments, the two selected indicators have significant differences, so they are suitable as feature values for classification.

A sampling frequency of the bipedal robot is set to 500 Hz, and the printing frequency is set to 100 Hz. An output frequency of detection results is 10 Hz, the bipedal robot is tested for more than 10 s, and at least 100 detection results are printed. The accuracy rate of the printed results is determined. Five real-time detections are performed on the grassland terrain and the hard flat terrain surfaces respectively, and detection accuracy rate is recorded. Taking the first detection as an example, a total of 158 detections are performed, of which 157 are correct, and the accuracy rate is expressed as:

$$γ = \frac{1}{n} {\sum }_{i = 1}^{n} {x}_{i} \times 100 \% = \frac{157}{158} \times 100 \% = 99.37 \% . \qquad ( 23 )$$

Experimental results and average accuracy rate of the remaining four groups are shown in Table 3.

TABLE 3
five real-time detections on soft grassland terrain and hard flat terrain conditions

| | Group | | | | | average |
|---|---|---|---|---|---|---|
| Terrain | 1 | 2 | 3 | 4 | 5 | value |
| Hard flat | 100.00% | 97.3% | 87.67% | 84.06% | 100.00% | 93.8% |
| terrain | | | | | | |
| Soft | 99.37% | 98.19% | 100.00% | 97.47% | 97.3% | 98.47% |
| grassland | | | | | | |
| terrain | | | | | | |
| Average | 99.69% | 97.75% | 93.84% | 90.77% | 98.65% | 96.135% |
| value | | | | | | |

The detection results indicate that the KNN classification algorithm achieves a classification accuracy rate of over 90% for both the hard flat terrain and the grassland terrain, meeting the requirements for real-time detection. Meanwhile, the bipedal robot changes the control strategy in real time based on the detection results to adapt to different motion requirements.

Herein, the gait and the step frequency of the bipedal robot are adjusted based on the detection results.

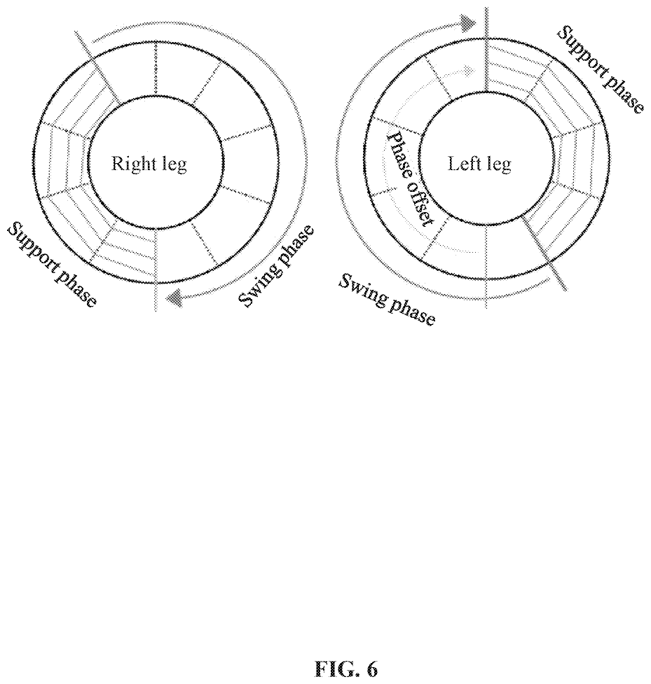

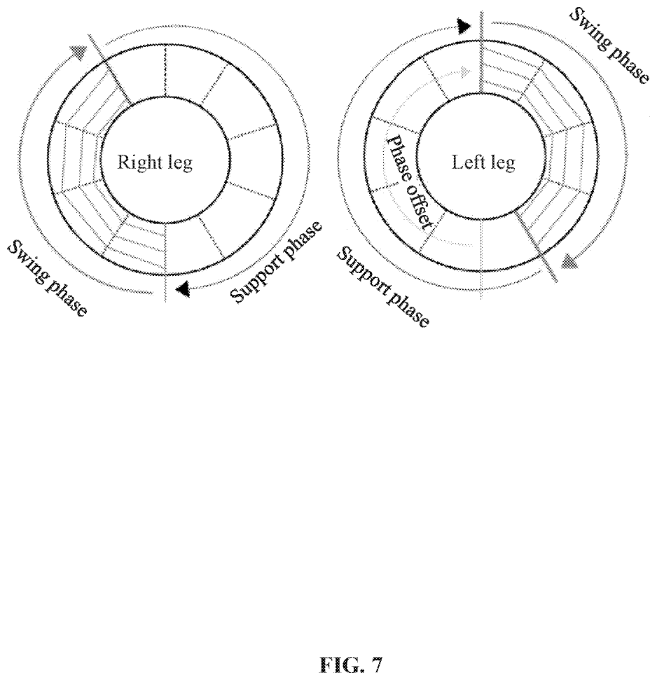

FIG. 6 is a schematic diagram illustrating a phase relationship of a flight gait according to some embodiments of the present disclosure, and FIG. 7 is a schematic diagram illustrating a phase relationship of a walking gait according to some embodiments of the present disclosure.

The bipedal robot has a relatively small count of limbs and legs, resulting in a relatively single combination of gaits. The bipedal robot in the embodiment is designed with two gaits. One is a walking mode with a complete double-foot flight phase as shown in FIG. 6, which is defined as a flight gait (also referred to as flying walking). The other is a walking mode with a double-foot support phase as shown in FIG. 7, which is defined as a walking gait (also referred to as walking).

In FIG. 6 and FIG. 7, two circular diagrams respectively illustrate phase relationships of the bipedal robot in different gait modes. The circles in each diagram denote legs of the bipedal robot, while arrows and lines at both ends of the arrows within the circles are used to indicate different phases and characteristics of the gait.

In bipedal walking, the support phase refers to a stage where a leg contacts the ground and supports the weight of the bipedal robot. In the support phase, the leg provides necessary stability and force to maintain standing and walking of the bipedal robot. The swing phase refers to a stage where the leg moves in the air without contacting the ground. In the swing phase, the leg prepares to move to a next support position to continue walking or running.

$$Duty cycle = support phase time of a single leg / gait cycle ( 24 ) .$$

The duty cycle, usually denoted by the symbol ρ, is used to define a time proportion of a support phase (also referred to as stance phase) of a single leg in a gait cycle of a bipedal or multi-legged robot, and is a ratio between 0 and 1. In the flight gait, the duty cycle is less than 0.5. In the walking gait, the duty cycle is greater than 0.5.

Preferably, when the bipedal robot is in a rough environment, such as the grassland terrain in this experiment, the step frequency of the bipedal robot is appropriately reduced, the support phase duty cycle of the bipedal robot is set to ρ=0.6, and the walking gait is selected, so that the bipedal robot can adjust its own balance more quickly in the rough environment. On the flat terrain, the step frequency is appropriately increased, the support phase duty cycle of the bipedal robot is set to ρ=0.4, and the flight gait is selected. Other control strategies, such as friction coefficients, are adjusted in real time according to the roughness of the terrain.

The step frequency refers to a count of stepping actions completed by the bipedal robot per unit time during walking or moving. The step frequency is preset and adjusted in real time according to the terrain where the bipedal robot is located, task requirements, or control strategies.

The walking gait refers to a motion mode of the bipedal robot, characterized in that the bipedal robot always has at least one leg in contact with the ground, i.e., having a double-foot support phase.

The flight gait refers to a motion mode of the bipedal robot, characterized in that there is a phase where both feet are simultaneously off the ground during the motion of the bipedal robot.

The walking gait and the flight gait are selected based on the terrain recognition result or motion planning, and are executed by the robot controller.

The support phase duty cycle refers to a proportion of time during which a single leg contacts the ground and supports the weight of the robot in a gait cycle of the bipedal robot.

The support phase duty cycle, as a parameter of gait planning, is set according to motion stability, efficiency, and terrain characteristics.

In one or more embodiments of the present disclosure, based on the terrain recognition result, the robot controller is capable of flexibly adjusting the step frequency and gait of the bipedal robot in different terrain situations according to a preset gait control strategy, so that the bipedal robot can maintain an optimal walking effect in different terrains, improving walking efficiency and adaptability of the bipedal robot.

In one or more embodiments of the present disclosure, by setting a duty cycle of ρ=0.6 on the rough terrain and ρ=0.4 on the flat terrain, a balance between stability and speed is achieved, thereby improving safety, efficiency, and engineering feasibility of the bipedal robot in different terrains.

It should be understood that those skilled in the art may adjust the support phase duty cycle according to actual situations, and the embodiment only provides an optional solution.

Compared to terrain recognition relying solely on foot force signals, one or more embodiments of the present disclosure achieve a more comprehensive and in-depth perception of walking environment of the bipedal robot by first determining the optimal foot force and simultaneously collecting foot force and pitch angle information under this constraint condition. Determination of the optimal foot force ensures that the bipedal robot maintains a stable and efficient gait during walking, and addition of the pitch angle data further enriches dimensions of the terrain recognition.

In the one or more embodiments of the present disclosure, it can achieve accurate judgment of different terrains by collecting the pitch angle data and the foot force data of the bipedal robot in real time and performing the terrain recognition using a trained KNN model. This not only improves adaptability of the bipedal robot in complex environments but also ensures stability and safety of the bipedal robot during walking. At the same time, by determining the optimal foot force, the center-of-mass dynamics equation and the constraint conditions are constructed, providing an accurate mathematical model for the gait control of the bipedal robot. On this basis, the robot controller can flexibly adjust the step frequency and the gait according to the terrain recognition result, thereby maintaining robust walking on the rough terrain and improving walking efficiency on the flat terrain. This intelligent terrain recognition and gait control manner provides a new solution for autonomous walking and navigation of the bipedal robot and has significant practical application value.

### Embodiment 2

The embodiment provides a robot perception based terrain recognition and gait control system.

In some embodiments, a training process of the KNN model specifically includes: driving the bipedal robot to perform autonomous navigation on a flat terrain and a rough terrain, and acquiring a sample dataset D1 and a sample dataset D2 including roll angles, pitch angles, and foot forces, respectively; extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and using a KNN algorithm for training, selecting a feature combination with a highest classification accuracy rate for experimental validation, recording a success rate of each group of tests, and determining an optimal k value to optimize model performance of the KNN model.

In some embodiments, the system achieves integrated control of terrain perception and gait adjustment by integrating a data acquisition module, a terrain recognition module, and a gait control module, combined with adaptive feature selection of the KNN algorithm, significantly improving walking stability and intelligence level of the bipedal robot on different terrains.

The embodiment can accurately recognize a terrain on which the bipedal robot is currently walking by collecting pitch angle data and foot force data of the bipedal robot in real time under constraints of the optimal foot force and inputting the data into a trained KNN model, achieving adaptive walking on different terrains, thereby improving adaptability and stability of the bipedal robot in complex environments and avoiding problems such as falling or walking difficulties caused by terrain changes.

### Embodiment 3

The embodiment provides a non-transitory computer readable storage medium, having a computer program stored thereon, when the computer program is executed by a processor, operations in the robot perception based terrain recognition and gait control method are implemented.

### Embodiment 4

The embodiment provides a computer device, including a memory, a processor, and a computer program stored in the memory and executable on the processor, when the computer program is executed, the processor implements operations in the robot perception based terrain recognition and gait control method.

Operations or modules involved in Embodiments 2 to 4 above correspond to Embodiment 1, and specific implementation manners may refer to relevant descriptions of Embodiment 1. The term “computer readable storage medium” should be understood as a single medium or a plurality of media containing one or more instruction sets; it should also be understood as any medium that is capable of storing, encoding, or carrying a set of instructions for execution by a processor and that causes the processor to perform any method in the present disclosure.

The foregoing descriptions are merely preferred embodiments of the present disclosure and are not intended to limit the present disclosure. For those skilled in the art, the present disclosure may have various modifications and changes. Any modifications, equivalent replacements, improvements, etc., made within the spirit and principles of the present disclosure shall be included within the scope of protection of the present disclosure.

What is claimed is:

1. A robot perception based terrain recognition and gait control method, comprising:
acquiring pitch angle data and foot force data of a bipedal robot based on optimal foot forces;
inputting the pitch angle data and the foot force data into a trained k-nearest neighbor (KNN) model to recognize a terrain on which the bipedal robot is currently walking, and obtaining a terrain recognition result; and
receiving, by a robot controller, the terrain recognition result, and adjusting a step frequency and a gait of the bipedal robot based on the terrain recognition result according to a preset gait control strategy;
wherein a training process of the KNN model includes:
driving the bipedal robot to perform autonomous navigation on a flat terrain and a rough terrain, and acquiring a sample dataset D1 and a sample dataset D2 including roll angles, pitch angles, and foot forces, respectively;
extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and
using a KNN algorithm for training, selecting a feature combination with a highest classification accuracy rate for experimental validation, recording a success rate of each group of tests, and determining an optimal k value to optimize model performance of the KNN model.

2. The robot perception based terrain recognition and gait control method of claim 1, wherein a process for determining the optimal foot forces includes:
performing a force analysis and a modeling operation on the bipedal robot to obtain ground reaction forces of two feet of the bipedal robot and position vectors starting from a center of mass and pointing to foot ends of the two feet, respectively;
constructing a center-of-mass motion state equation based on the ground reaction forces of the two feet and the position vectors, and simplifying the center-of-mass motion state equation to obtain a center-of-mass dynamics equation including a desired center of mass linear acceleration and a desired body angular acceleration;
constructing a constraint condition based on a stable motion; and
constructing an optimization equation according to the center-of-mass dynamics equation and the constraint condition, simplifying a cost function into a standard quadratic programming problem, and solving the standard quadratic programming problem to obtain the optimal foot forces.

3. The robot perception based terrain recognition and gait control method of claim 2, wherein the center-of-mass dynamics equation is:
$${\underbrace{[ \begin{matrix}{II}_{3} & {II}_{3} \\ {[ {p}_{f 1} - {p}_{COM} ]}_{\times } & {[ {p}_{f 2} - {p}_{COM} ]}_{\times }\end{matrix} ]}}_{A} {\underbrace{[ \begin{matrix}{f}_{1} \\ {f}_{1}\end{matrix} ]}}_{f} = {\underbrace{[ \begin{matrix}m ( {p}_{d} + g ) \\ I {\dot{ω}}_{d}\end{matrix} ]}}_{b} ,$$
wherein, Π₃ is a 3×3 identity matrix, p_{f1} and p_{f2} respectively denote position vectors of foot ends in a world coordinate system, p_{COM} denotes a position vector of the center of mass in the world coordinate system, and the position vectors are obtained through a state estimation of the bipedal robot; f₁ and f₂ respectively denote foot forces of the two feet, m denotes a rigid-body mass of the bipedal robot simplified into a single rigid body, g denotes a gravitational acceleration, I denotes a moment of inertia, \ddot{p}_{d} and \dot{ω}_{d} denote the desired center of mass linear acceleration and the desired body angular acceleration, respectively, and the desired center of mass linear acceleration and the desired body angular acceleration are determined by designing a proportional-derivative (PD) controller.

4. The robot perception based terrain recognition and gait control method of claim 3, wherein the desired center of mass linear acceleration \ddot{p}_{d} is determined according to:
$${\ddot{p}}_{d} = {K}_{p , p} ( {P}_{d} - {P}_{C O M} ) + {K}_{d , p} ( {\dot{p}}_{d} - {\dot{p}}_{C O M} ) ,$$
wherein, p_{d} denotes a desired center-of-mass position, \dot{p}_{d} denotes a desired center-of-mass velocity, and K_{p,p} and K_{d,p} denote gain coefficients of the PD controller.

5. The robot perception based terrain recognition and gait control method of claim 3, wherein the desired body angular acceleration \dot{ω}_{d} is determined according to:
$${\dot{ω}}_{d} = {K}_{p , ω} log ( {R}_{d} {R}_{b} ) + {K}_{d , ω} ( {ω}_{d} - {ω}_{b} ) ,$$
wherein, ω_{d} denotes a desired body angular velocity, ω_{b} denotes a measured body angular velocity, R_{d} denotes a desired body posture rotation matrix, R_{b} denotes a measured body posture rotation matrix, and K_{p,ω} and K_{d,ω} denote gain coefficients of the PD controller.

6. The robot perception based terrain recognition and gait control method of claim 2, wherein the constructing a constraint condition based on a stable motion includes:
$$\{ \begin{matrix}{f}_{min} \leq {f}_{z} \leq {f}_{max} \\ - μ {f}_{z} \leq \sqrt{2} {f}_{x} \leq μ {f}_{z} \\ - μ {f}_{z} \leq \sqrt{2} {f}_{y} \leq μ {f}_{z}\end{matrix} ,$$
$$\sqrt{{f}_{x}^{2} + {f}_{y}^{2}} \leq μ {f}_{z} ,$$
wherein, μf_{z} denotes a friction cone constraint condition, fₓ, f_{y}, and f_{z} respectively denote foot forces along an X-axis, a Y-axis, and a Z-axis, and fₘₐₓ and fₘᵢₙ denote a maximum foot force threshold and a minimum foot force threshold, respectively.

7. The robot perception based terrain recognition and gait control method of claim 2, wherein a desired foot forces is expressed as a following optimization problem:
$${f}^{d} = arg {min}_{f ∈ {ℝ}^{3}} ( {( A f - b )}^{T} S ( A f - b ) + {f}^{T} Wf ) ,$$
$$s . t . {\underline{C}}_{i} \leq {C}_{i} {f}_{i} \leq {\overline{C}}_{i} = 1 , 2 ,$$
wherein, f denotes a foot force vector to be optimized, fₓ, f_{y}, and f_{z} in f respectively denote foot forces along an X-axis, a Y-axis, and a Z-axis, S∈ [symbol] ^{6×6} denotes a positive definite diagonal matrix used to describe an error weight of the foot forces following a desired motion state, f^{d} denotes a desired foot force vector, A denotes a center of mass dynamics matrix, b denotes a desired motion force vector, (⋅)^{T} denotes a transpose of a matrix or a vector, and W∈ [symbol] ^{6×6} denotes a positive definite diagonal matrix; s.t. denotes a constraint condition, Cᵢ denotes a coefficient matrix of an i-th foot end friction cone constraint, fᵢ denotes a foot force vector of the i-th foot end, Cᵢ denotes a lower bound vector of a constraint condition of the i-th foot end, and C̅ᵢ denotes an upper bound vector of the constraint condition of the i-th foot end;
wherein solving a quadratic programming problem is expressed as:
$${min}_{U} \frac{1}{2} {U}^{T} H U + {U}^{T} g ,$$
$$s . t . \underline{C} \leq CU \leq \overline{C} ,$$
wherein, U denotes an optimization variable of the standard quadratic programming problem, H denotes a quadratic coefficient matrix, C denotes a total constraint lower bound vector, C̅ denotes a total constraint upper bound vector, and C denotes a total constraint coefficient matrix;
wherein the cost function is transformed and simplified into the standard quadratic programming problem according to:
$$J ( f ) = {( A f - b )}^{T} S ( A f - b ) + {f}^{T} Wf = {( Af )}^{T} SAf - {( Af )}^{T} Sb - {b}^{T} SAf + {b}^{T} Sb + {f}^{T} Wf = {f}^{T} {A}^{T} SAf - 2 {f}^{T} {A}^{T} S b + {f}^{T} W f + {b}^{T} S b = {f}^{T} ( {A}^{T} S A + W ) f + {f}^{T} ( - 2 {A}^{T} S b ) + {b}^{T} Sb ,$$
wherein, J(f) denotes the cost function, b^{T}Sb is regarded as a constant term, and the matrix U, the matrix H, and a matrix g are respectively expressed as:
$$\{ \begin{matrix}U = f \\ H = 2 ( {A}^{T} S A + W ) , \\ g = - 2 {A}^{T} S b\end{matrix}$$
through which the process for determining the optimal foot forces is transformed into the quadratic programming problem.

8. The robot perception based terrain recognition and gait control method of claim 1, wherein
the pitch angle data includes three-axis angular velocity information acquired by a sensor installed at a head center of the bipedal robot;
a Y-axis of the sensor is consistent with a forward direction of the bipedal robot, an X-axis of the sensor is parallel to a lateral direction of a chassis of the bipedal robot, and a Z-axis of the sensor is perpendicular to a chassis plane of the chassis; and
angular velocity information of the Y-axis, the X-axis, and the Z-axis is respectively used to represent motion information of the bipedal robot in forward and backward tilting, left and right tilting, and turning motion.

9. The robot perception based terrain recognition and gait control method of claim 1, wherein the gait control strategy includes:
when the bipedal robot is on the rough terrain, slowing down the step frequency of the bipedal robot and selecting a walking gait; and
when the bipedal robot is on the flat terrain, speeding up the step frequency of the bipedal robot and selecting a flight gait.

10. The robot perception based terrain recognition and gait control method of claim 9, further comprising:
when the bipedal robot is on the rough terrain, a support phase duty factor ρ of the bipedal robot being 0.6; and
when the bipedal robot is on the flat terrain, the support phase duty factor ρ of the bipedal robot being 0.4.

11. The robot perception based terrain recognition and gait control method of claim 1, wherein when extracting the coefficient of variation and the variance of each sample data in the sample dataset D1 and the sample dataset D2 as features, the coefficient of variation is determined according to:
$$C V = \frac{σ}{μ} \times 100 \% ,$$
wherein, CV denotes the coefficient of variation, σ denotes a standard deviation of data, and u denotes an average value of the data;
wherein after determining the coefficient of variation and the variance, a matrix Nis obtained as:
$$N = [ \begin{matrix}{R}_{cv} & {R}_{v} \\ {P}_{c v} & {P}_{v} \\ {F}_{cv} & {F}_{v}\end{matrix} ] ,$$
wherein, R_{cv}, P_{cv}, and F_{cv} respectively denote the coefficient of variation of the roll angles, the pitch angles, and estimated foot force data, and Rᵥ, Pᵥ, and Fᵥ respectively denote the variance of the roll angles, the pitch angles, and the estimated foot force data.

12. The robot perception based terrain recognition and gait control method of claim 1, wherein the coefficient of variation and the variance of the roll angles, the pitch angles, and the estimated foot force data of the bipedal robot are used as two features input to the KNN algorithm for training; two features from different sample data are combined pairwise to generate feature combinations, traverse all possibilities of feature combinations, and the classification accuracy rate corresponding to the feature combinations are calculated respectively, which is expressed as:
$$f ( {N}_{ij} , {N}_{kj} ) , i = 1 , 2 ; j = 1 , 2 , 3 ,$$
wherein i and k denote feature types, including the roll angle, the pitch angle, and the foot force; j denotes statistical characteristics of the features, including the coefficient of variation and the variance; k≠i denotes selecting different feature types for combination.

13. A robot perception based terrain recognition and gait control system, comprising:
a data acquisition module, configured to acquire pitch angle data and foot force data of a bipedal robot based on optimal foot forces;
a terrain recognition module, configured to input the pitch angle data and the foot force data into a trained KNN model to recognize a terrain on which the bipedal robot is currently walking, and obtain a terrain recognition result; and
a gait control module, configured for a robot controller to receive the terrain recognition result, and adjust a step frequency and a gait of the bipedal robot based on the terrain recognition result according to a preset gait control strategy;
wherein a training process of the KNN model includes:
driving the bipedal robot to perform autonomous navigation on a flat terrain and a rough terrain, acquiring a sample dataset D1 and a sample dataset D2 including roll angles, pitch angles, and foot forces, respectively;
extracting a coefficient of variation and a variance of each sample data in the sample dataset D1 and the sample dataset D2 as features, and dividing the sample dataset D1 and the sample dataset D2 into a training set and a validation set, wherein a sliding window algorithm is used to determine the coefficient of variation and the variance, and a window size and an interval are determined according to a data printing frequency; and
using a KNN algorithm for training, selecting a feature combination with a highest classification accuracy rate for experimental validation, recording a success rate of each group of tests, and determining an optimal k value to optimize model performance of the KNN model.

14. A non-transitory computer readable storage medium having a computer program stored thereon, wherein when the computer program is executed by a processor, operations in the robot perception based terrain recognition and gait control method of claim 1 are implemented.

15. A computer device, comprising a memory, a processor, and a computer program stored in the memory and executable on the processor, wherein when the computer program is executed, the processor implements operations in the robot perception based terrain recognition and gait control method of claim 1.
